(19) United States
(12) Patent Application Publication
(10) Pub. No.: US 2009/0006126 A1
(43) Pub. Date: Jan. 1, 2009

(54) Prescription transmission system and method

(76) Inventor: Andre Champigny, Ammon (CA)

Correspondence Address: Franz BONSANG;c/o EQUINOX PROTECTION, 410- 1500, Du College, St-Laurent, QBC, H4L 5G6, CA

(21) Appl. No.: 11/819,349

(22) Filed: Jun. 27, 2007

(51) Int. Cl. G06Q 50/00

(52) U.S. Cl. 705/2

(57) ABSTRACT

A system and method for processing a prescription wherein the prescription may be transmitted to a selected pharmacy from a remote location situated remote from the selected pharmacy is provided. A prescription is described by either a new prescription dataset entered on a prescription form or a refill prescription dataset. A client uses a client computing device situated in the remote location to select the selected pharmacy and to transmit the prescription dataset thereto. The client may then later attend at the selected pharmacy to retrieve the prescription. Prescription datasets may be transmitted to the selected pharmacy either electronically or verbally using client telephony device connected to the client computing device, and preferably housed therewith, in the remote location. A client scanner device may be used for converting new prescription forms for new prescription into scanned images thereof for electronic transfer to the selected pharmacy.

### FIELD OF THE INVENTION

The present invention relates to processing pharmaceutical prescriptions and is more particularly concerned with a system and method for transmitting prescriptions to a pharmacy.

### BACKGROUND OF THE INVENTION

It is well known in the art to use computing devices and networks to process and transmit pharmaceutical prescriptions issued by a prescribing health professional, such as a doctor, dentist or the like, for a patient to a pharmacy where the prescription is filled. For example, U.S. patent application Ser. No. 10/650,899, filed for Kaafarani et al. on Aug. 28, 2003 teaches a system wherein a client, such as a patient, may scan a prescription at a kiosk, perhaps situated at the prescribing health professionals office, and have the prescription electronically transmitted over a network to a pharmacy situated remotely from the kiosk. The system and method taught by Kaafarani et al. also allows the client to locate and choose a pharmacy at a desired location and to which the prescription, once scanned is sent, for processing thereof and subsequent pick up. The system and method taught by Kaafarani et al. further provides for a telephone connection between the pharmacy and the patient at the kiosk, thus permitting the client to speak with a pharmacist or other pharmacy employee et the pharmacy to confirm the information, i.e. a prescription dataset, on the prescription sent to the pharmacy. Thus, the system and method taught by Kaafarani et al. allows a client having a prescription issued by a prescriber to transmit the prescription to a desired pharmacy from a remote location and to subsequently pick up the prescription once the prescription has been processed by the pharmacy, thereby allowing the client to minimize waiting time at the pharmacy. Disadvantageously, however, Kaafarani et al. does not provide for validating that the prescription provided by the client has been issued by a prescriber authorized to issue prescriptions. For example, Kaafarani et al. do not provide for preventing filling of a prescription written by an unauthorized person on a prescription form stolen from a prescriber. Further, while a patient may telephone the desired pharmacy from the kiosk, this requires that the patient dial the telephone number from the kiosk, which may be cumbersome.

U.S. patent application Ser. No. 11/292,113, filed for Austin et al. on Dec. 2, 2005, similarly, also allows a client having a prescription to input the prescription into a kiosk situated in a remote location from a desired pharmacy and to electronically transmit the prescription therefrom to the pharmacy for subsequent pick-up of the prescription, once filled, at the pharmacy. Austin et al. also provides for communication between the pharmacy and the kiosk by telephone, as well as by other means. Additionally, Austin et al. provide for validation of the identity of the client, and possibly the prescriber, by validation of biometric information, for example fingerprints or facial scans, stored in the system. However, use of such biometric information raises privacy concerns for many people, who may hesitate to provide it to the system. Accordingly, there is a need for an improved method and system for processing a prescription by which transmission of a prescription to a selected pharmacy from a remote location is simplified and which provides for simplified verification of the identity of the client or the prescriber.

### SUMMARY OF THE INVENTION

It is therefore a general object of the present invention to provide an improved method and system for transmitting prescriptions to pharmacies and processing thereof.

An advantage of the present invention is that the system and method provided thereby provides for validation that the prescription has been actually issued by a prescriber.

Another advantage of the present invention is that the validation that the prescription has been issued by the prescriber is provided by use of information that is already typically provided by prescribers.

A further advantage of the present invention is that the client may contact the desired pharmacy by telephone without having to manually dial the telephone number of the desired pharmacy.

In one aspect, the present invention provides a method for processing a prescription prescribing medication wherein the prescription is transmittable to a selected pharmacy by a client situated at a remote location remote from the selected pharmacy, the method comprising the steps of:
a) receiving a pharmacy selection designating the selected pharmacy from the client at the remote location;
b) when the prescription is a refill prescription, transmitting a refill prescription dataset describing the refill prescription to the selected pharmacy;
c) when the prescription is a new prescription;
   i) scanning a prescription form having a new prescription dataset defining the new prescription inscribed thereon into a scanned prescription image thereof containing the new prescription dataset;
   ii) electronically transmitting the scanned prescription image to the selected pharmacy;
   iii) establishing a telephone connection between the remote location and the selected pharmacy; and
   iv) using the telephone connection, verbally confirming by a pharmacist with the client of the new prescription dataset in the scanned prescription image received at the selected pharmacy.

In another aspect, the present invention provides a prescription processing system for enabling transmission of a prescription emitted by a prescriber for a patient to a selected pharmacy from a remote location situated remote from the selected pharmacy, the system comprising:
at least one client scanner situated in the remote location for scanning a prescription form on which a new prescription dataset for a new prescription is inscribed into a scanned prescription image containing the new prescription dataset;
at least one client telephony device situated in the remote location; and
at least one client computing device connected to the client scanner, to the client telephony device, and to a pharmacy database of available pharmacies, the client computing device receiving a pharmacy selection from a client in the remote location designating the selected pharmacy from the available pharmacies, receiving the scanned prescription image from the client scanner, transmitting the scanned prescription image to a pharmacy prescription receiving device accessible from the selected pharmacy and connected to the client computer device by a data-enabled network, and controlling establishment of a telephone connection over a telephony-enabled network by the client telephony device with a pharmacy telephony device, connected thereto by the telephony-enabled network, for verifying the new prescription dataset.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a system diagram of a prescription processing system enabling transmission of a prescription to a pharmacy for processing thereof in accordance with an embodiment of the present invention;

FIG. 2 is a system diagram showing the modules deployed in a client computing device, a server computing device, and a prescriber computing device deployed in the system shown in FIG. 1;

FIG. 3 is a diagram showing the data stored in a prescriber database, a prescription database, and a pharmacy database shown in FIG. 2 and deployed in the system shown in FIG. 1;

FIG. 3a is a diagram showing software components for a reading module and a signature module shown in FIG. 2 and deployed in the system shown in FIG. 1;

FIG. 4 is a depiction of a predefined standardized prescription form configured for use with the system shown in FIG. 1;

FIG. 5 is a flow chart showing a non-standardized prescription form usable with the system shown in FIG. 1;

FIG. 6 is a flowchart depicting a method for processing a prescription prescribing medication wherein the prescription is transmittable to a selected pharmacy by a client situated at a remote location remote from the selected pharmacy, in accordance with an embodiment of the present invention; and

FIG. 7 is a flowchart depicting the steps for selecting a selected pharmacy for the method shown in FIG. 6.

### DETAILED DESCRIPTION OF THE PREFERRED EMBODIMENTS

With reference to the annexed drawings the preferred embodiments of the present invention will be herein described for indicative purpose and by no means as of limitation. For the purposes of this description, the following meaning is ascribed to the following terms:

Prescriber: A person, typically a health care professional, who emits a prescription for a medication.

Client: A person, typically, but not necessarily, a patient for whom a prescription is emitted, which submits the prescription to a pharmacy for processing using the system and method of the present invention.

Pharmacist: A person, typically a pharmacist or a person employed thereby, who works in or for a pharmacy.

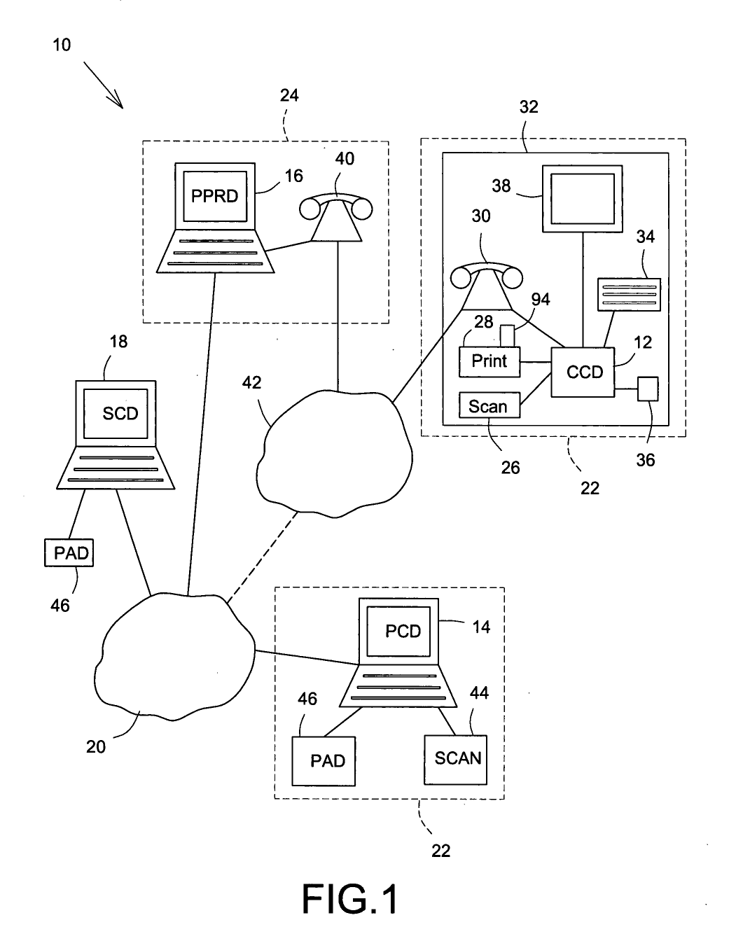

Referring to FIG. 1, there is schematically shown a first embodiment of a prescription processing system, shown generally as 10, for processing a prescription issued by a prescriber for a patient and which enables transmission of the prescription from a remote location 22 to a selected pharmacy 24. As shown, the system 10 includes at least one client computing device (CCD) 12, at least one prescriber computing device (PCD) 14, and at least one pharmacy prescription receiving device (PPRD) 16, which are preferably connected to at least one server computing device (SCD) 18 via a first, data-enabled network 20 capable of transmitting data.

Referring now to FIGS. 1, 2, and 3, CCDs 12 are generally, but not necessarily, situated in a remote, i.e. different, location 22, preferably a prescriber's office, that is situated remote from a pharmacy 24 where a PPRD 16, by which a new or refill prescription dataset 25, 27 describing the prescription is received by the pharmacy 24, is situated. For example, the remote location 22 could be a prescriber's office, situated in the same building or in a different building than the pharmacy 24. Each CCD 12 is connected to a client scanner 26, a client printer 28, and a client telephony device (CTD) 30 which are controlled by CCD 12 and situated proximal thereto in the remote location 22. Ideally, the CCD 12, the client scanner 26, the client printer 28, and the client telephony device 30 are housed together in a housing 32, shown as a kiosk, situated in the remote location 22. The CCD 12 typically has at least one video display unit 38 for displaying information, as well as at least one client input device connected thereto for receiving client inputs, such as choices from the client or entry of data. Preferably the display unit 38 is a touch screen 38, by which clients make client inputs by touching the screen 38, and thus also constitutes a client input device. Other client input devices may also be connected to a CCD 12, such as, for example a keyboard 34, and a pointing device 36, such as a mouse or trackball, or the like. The client input devices 34, 36, 38, are also, preferably, housed within the housing 32 or readily accessible therefrom.

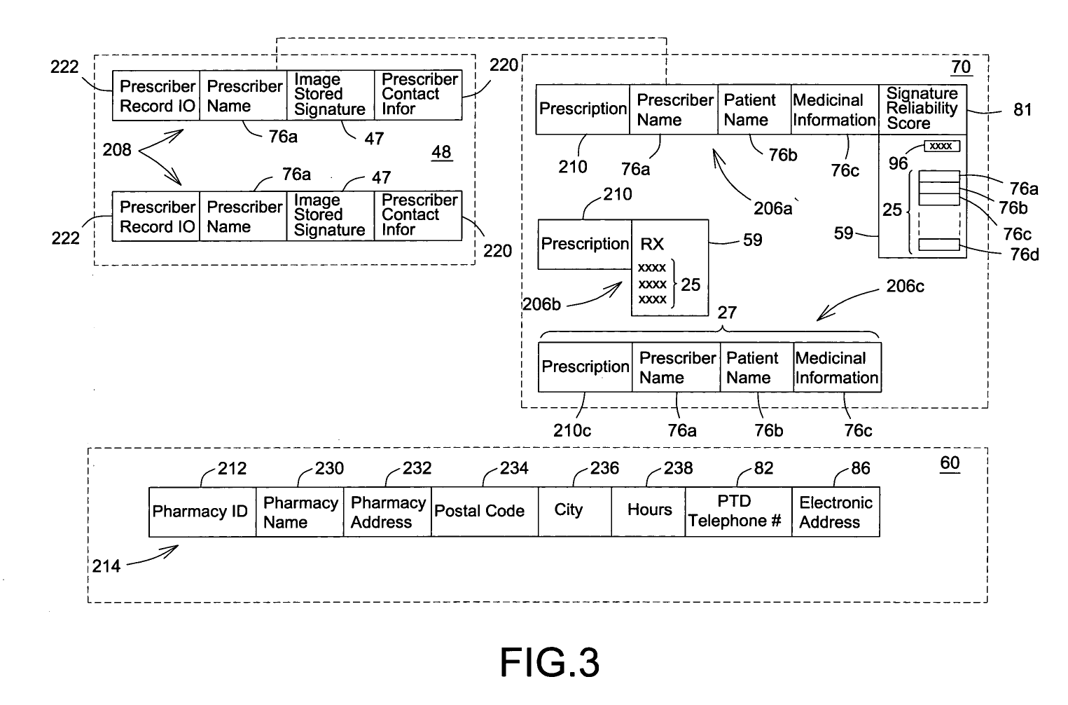

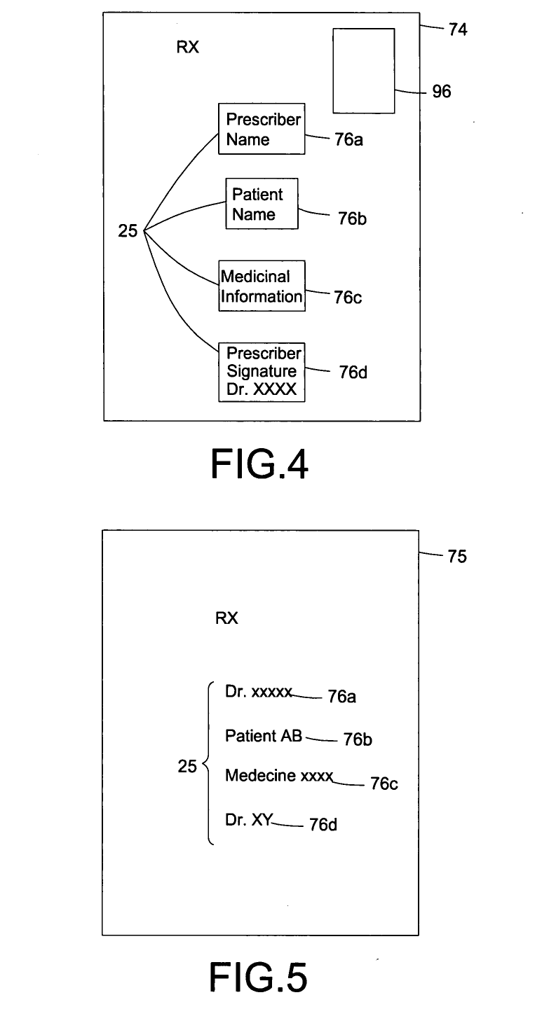

Referring now to FIGS. 1, 3, 4, and 5, the client scanner 26 is used for receiving a predefined standardized prescription form 74 or non-standardized prescription form 75, both types prescription forms 74, 75 having a new prescription inscribed thereon, namely as a new prescription datasets 25 describing the new prescription. As best shown in FIGS. 3 and 5, the new prescription dataset 25 generally includes, as a minimum, a prescriber name 76a of a prescriber issuing the prescription, a patient name 76b of the patient for whom the presciption is issued, medicinal information 76c indicating the medication prescribed and the dosage thereof, and the prescriber's signature 76d. The client scanner 26 receives the prescription form 74, 75 and scans, i.e. digitizes, the prescription form 74, 75 into a digitized scanned prescription image 59 of the prescription form 74, 75, therefore containing a scanned image of the new prescription dataset 25, on the CCD 12. For example, the prescription form 74, 75could be scanned into an image in Joint Photographic Experts Group (JPEG) format, Graphic Interchange format (GIF), bitmap format (BMP), Tag Image File format (TIFF), or the like.

The CTD 30, controlled by the CCD 12, is used for telephonic verbal communication between the client, using the client telephony device 30, and a pharmacist at the pharmacy 24 using a pharmacy telephony device (PTD) 40 situated therein. Each PTD 40 and each CTD 38 are connected to a second, telephony-enabled network 42 upon which verbal telephone communication is carried therebetween.

Referring again to FIGS. 1, 2, and 3, the PCD 14, which is typically used by the prescriber, has a prescriber scanner 44 (26) connected thereto, which is used for scanning prescription forms 74 thereinto, in the same fashion as the client scanner 26. Also, like the client computing device, the PCD 14 and PPCD 16 may have a keyboard 34, pointing device 36, and a video display unit 38 connected thereto. The PCD 14 may, optionally, also have a digital signature pad 46 connected thereto and upon which the prescriber may inscribe her or his signature, which is digitized into a digitized stored signature image 47 thereof and transmitted to the PCD 14, which in turn stores the stored signature image and/or transmits the stored signature image to the SCD 18 for storage thereupon. Alternatively, the digital signature pad 46 could be connected to the SCD 18, although, in this case, the prescriber would be required to visit the location where the SCD 18 is situated to inscribe her or his signature on the pad 46 for storage as a stored signature image on the SCD 18. As a further alternative, the prescriber may inscribe her or his signature on a piece of paper or the like and use the prescriber scanner 44 to scan the signature to create the stored signature image 47. The stored signature image 47 is used to verify the prescriber's signature on the prescription form 74 and thereby authenticate that the prescription form 47 has, in fact, been issued by a prescriber, registered, i.e. inscribed, in the system 10. In general, the stored signature image 47 is stored in a prescriber database 48 situated on the SCD 18, with possibly a local copy of the prescriber database 48 stored on the PCD 14. As best shown in FIG. 3, for each prescriber registered with the system 10, the prescriber database 48 contains a respective prescriber record, shown generally as 208, for each prescriber. The prescriber record 208, includes a unique prescriber record identifier 222, the prescriber name 76a, prescriber contact information 220, and stored signature image 47 therefor.

Preferably the PCD 14, PPRD 16, and CCD 12 will be conventional personal computers. However, other devices, for example portable computers, cellular phones, and personal digital assistants, could also be used for the PCD 14 and CCD 12 provided they are capable of processing prescription datasets and are connectable to the first network 20 and to elements 26, 34, 36, 38, 44. In the event that the selected pharmacy 24 should only need to receive an image of the prescription, the PPPD 16 could also be a simple facsimile machine or the like.

The first network 20 may be a wireline network, wireless network, or combination thereof, and may be a local area network, wide area network, public or private network. Ideally, however, the first network 20 will be the Internet, or at least connected to the Internet. The second network 42 may be any network capable of carrying telephonic voice communication, including conventional telephone networks or data networks, such as the Internet, that are telephony-enabled, for example, by use of Voice over Internet Protocol (VOIP) technology. To the extent that the first network 20 may be capable of carrying telephonic voice communication, the first network 20 and the second network 42 may be the same network. The telephony devices 30, 40 may be any device upon which a verbal telephone communication, such as a telephone conversation, may be carried on. However, the CTD 30 must be a device that can be controlled by the CCD 12 such that the CCD 12, and more specifically a telephony control module 50 thereof, such as an interface, may instruct the CTD 30 to dial telephone numbers and/or otherwise establish telephone connections with other telephony devices, notably the PTD 40.

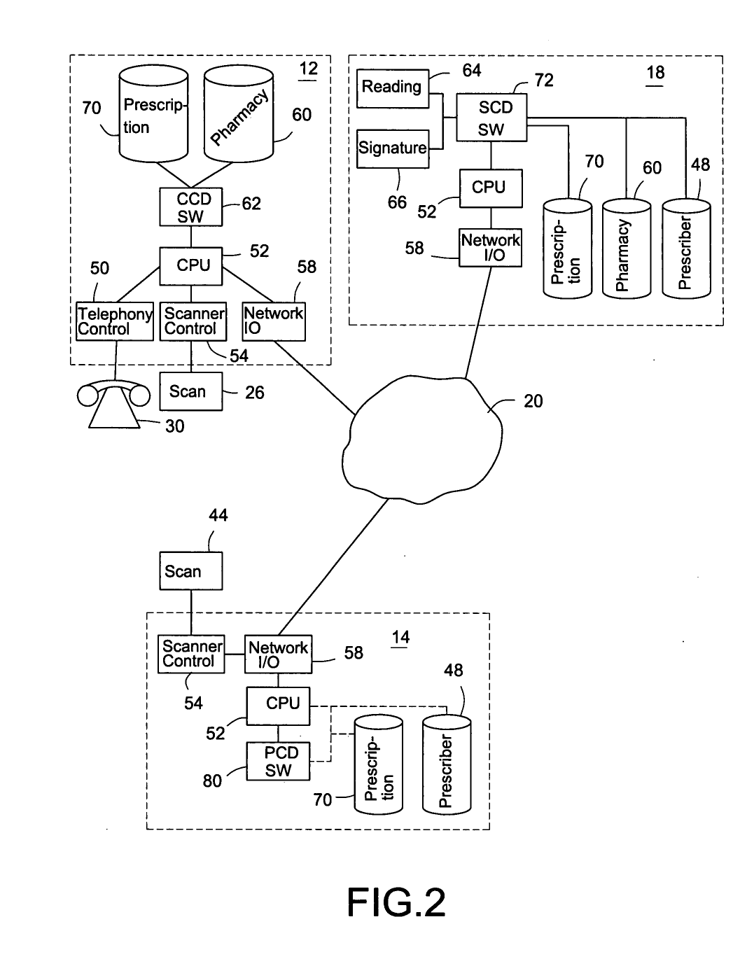

Having described the system 10 in general, the modules of the CCD 12, PCD 16, and SCD 18 will now be described in further detail with reference to FIGS. 2, 3, 4, and 5. As shown in FIG. 2, each CCD 12 has a central processing unit (CPU) 52, such as a microprocessor or the like, which executes instructions and controls the scanner control module 54 and the telephony control module 50 of the CCD 12. The CPU 52, in turn, receives instructions from a CCD software module 62 resident on the CCD 12, as well as from the SCD 18 which sends instructions to the CCD software module 62. Thus, the CCD software module 62 acts as a client, with the SCD 18 acting as a server. The CPU 52 of the C CD 12 is connected via a network interface 58, to the first network 20 for communication with the SCD 18.

Referring now to FIGS. 1, 3, 4, and 5, the CCD 12 may be used by the client to either transmit a refill prescription, i.e. a prescription that has already been filled at least once, or a new prescription, i.e. a prescription that has not already been filled once, to a pharmacy 24, and notably a selected pharmacy 24 selected by the client. For new prescriptions, the scanner controller module 54, connected to the CPU 52 and preferably acting as an interface therebetween, controls the client scanner 26 which receives the prescription form 74, 75 for new prescriptions and controls scanning thereby of the prescription form 74 with the new prescription dataset 25 inscribed thereon into the scanned prescription image 59 thereof. The scanned prescription image 59 is then, preferably, transmitted by the CPU 52 to the SCD 18 which then transmits the scanned prescription image to the PPRD 16. However, should the SCD 18 be absent, or unavailable, the CCD 14 will transmit the scanned prescription image 59 over the first network 20 directly to the PPRD 16 and will store a copy of the scanned prescription image on the CCD 12. For refill prescriptions, the client may transmit a refill prescription dataset 27, which includes at least a unique prescription identifier 210 identifying the prescription, to the selected pharmacy 24 either electronically, in which case the refill prescription dataset is transmitted over the first network 20 from the CCD 12, possibly via the SCD 18, to the PRRD 16 of the selected pharmacy 24, or verbally by using the CTD 30 to establish a telephone connection to the PTD 40 to talk to a pharmacist. The choice of the method by which the refill prescription is transmitted to the selected pharmacy 24 is made by using one or more of the client input devices 34, 36, 38 on the CCD 12. If the client chooses to transmit the refill prescription to the selected pharmacy 24 electronically, the client enters the refill prescription dataset 27on the CCD 12 using the client input devices 34, 35, 38 and the CCD 12 transmits the refill prescription dataset 27 over first network to the PPRD 16, with the refill prescription dataset 27 possibly being stored on the SCD 12 or the PPRD 16. If the client chooses to transmit the refill prescription by telephone to the selected pharmacy 24, then the CCD 12 establishes a telephone connection between the CTD 30 and the PTD 40, as described below, on the second network 40 to allow the client to verbally communicate the prescription refill dataset 27 to a pharmacist at the selected pharmacy. The pharmacy refill dataset 27 may include, in addition to the unique prescription identifier, the prescriber name 76a, the patient name 76b, and medicinal information 76c, previously described.

Referring to FIGS. 1, 2, and 3, the telephony control module 50, connected to the CPU 52, controls the CTD 30 and instructs the client telephony device 30 to establish telephone connections with PTD 40 of the selected pharmacy 24 selected by the client. Specifically, the CPU 52, based on instructions received from the CCD software module 62, transmits a PTD telephone number 82 for the PTD 40 of the selected pharmacy 24 to the telephony control module 50, which in turn causes the CTD 30 to dial the PTD telephone number 82 of the PTD 40 of the selected pharmacy 24 to establish a telephone connection therewith. The telephony control module 50 also monitors the client telephony device 30 and generates a signal when a telephone connection is actually established with the PTD 40. The signal, which may be sent to the CPU 52 of the CCD 12, causes the CCD 12 to emit a sonorous or visual signal to alert the client that the telephone connection has been established and that the client may commence a verbal conversation using the CTD 30 with a pharmacist, which uses the PTD 40 at the selected pharmacy 24, to communicate the refill prescription dataset 27 thereto or to verify the new prescription dataset 25 received by the PPRD 16 at the selected pharmacy 24. Obviously, the telephone connection may also be used for exchange of additional information between the pharmacist and the client, such as client allergies, costs, side effects, or the like, if desired. The telephone connection may also be used by the client for entry of information, including the refill prescription dataset 27, into an automated telephony system at the pharmacy 24 by using a conventional telephone keypad, not shown, on the CTD 30. The telephony control module 50 also monitors the telephone connection to determine when the telephone connection between the CTD 30 and the PTD 40 is terminated or when the PTD 40 is unavailable, for example when the PTD 40 is busy, such that an appropriate visual or sonorous signal is generated by the CCD 12 to alert the client that the telephone connection has been terminated or is unavailable.

Referring now to FIGS. 1, 2, and 3, at least one respective PTD telephone number 82 for each PTD 40 in a pharmacy 24 is stored in a pharmacy database 60, which contains at least one pharmacy record 214 for each pharmacy registered with the system 10. Each pharmacy record includes, among other things, a unique pharmacy identifier 212, the pharmacy name 230, the pharmacy address 232, the postal or zip code 234 of the pharmacy 24, a PTD telephone number 82 for each PTD 40 thereof, the city or locality 236 in which the pharmacy 24 is situated, and an electronic address 86 for the PPRD 16 thereof and to which electronic data may be sent. Such electronic data sent to the electronic address of the PPRD 16 may include, for example, the scanned prescription image 59, the refill prescription dataset 27, or the new prescription dataset 25. The electronic address may be, for example, an e-mail address accessible by the PPRD 16, an Internet protocol address of the PPRD 16, or, if the PPRD 16 is a fax machine, a telephone number therefore. The pharmacy record 214 may also contain the hours of operation 238 for the pharmacy 24. The pharmacy database 60 is, preferably, stored on the SCD 18 and is thereby accessible by the CCD 12 via the first network 20. However, as shown in FIG. 2, a local copy, or mirror, of the pharmacy database 60 may also be stored on each CCD 12. The selected pharmacy 24 to which the prescription dataset is sent is selected by the client by using the client input devices 34, 36, 38 from a list of available pharmacies 24 displayed by the CCD 12. The list of available pharmacies 24 displayed is generated by searching the pharmacy database 60 using search criteria, such as the address 232 of the pharmacy 24, the pharmacy name 230, postal code 234 of the pharmacy 24, the city or locality 236, the hours of operation 238, or the like, entered by the user on the CCD 12 using the client input devices 34, 36, 38.

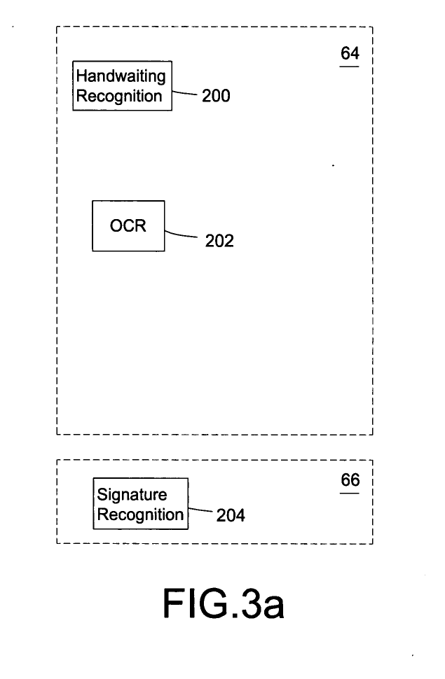

Referring now to FIGS. 1, 2, and 4, the SCD 18 also has a CPU 52 which controls, and connects, the reading module 64, signature module 66, pharmacy database 60, prescriber database 48, and prescription database 70. The CPU 52 of the SCD 18 also communicates with the CCD 12, and possibly the PPRD 16, via the network interface 58 over the first network 20. The CPU 52, in turn, receives instructions from the SCD software module 72. The prescription database 70 stores, for new prescriptions, scanned prescription images 59, containing images of the new prescription dataset 25, received by the SCD 18 from the CCD 12 and that are forwarded by the SCD 18 to the PPRD 16 of the selected pharmacy 24. Each new prescription received by the system 10 is stored in the prescription database 70 as a prescription record 206 having, as a minimum, a unique prescription identifier 210 associated therewith, along with the scanned prescription image 59 therefor and containing images of the new prescription dataset 25. This is the case for prescription record 206b for a new prescription inscribed on non-standardized prescription form 75, shown in FIG. 5. If the new prescription is inscribed on a standardized prescription form, shown in FIG. 4, the prescription record 206a may also contain the prescriber name 76a, the patient name 76b, and the medicinal information 76c of the new prescription dataset 25 converted into a machine readable text format, as well as a signature reliability score 81, explained below. For refill prescriptions, the prescription record 206c includes the prescription identifier 210 as well as the refill prescription dataset 27, described previously.

Referring more particularly now to FIGS. 3, 3a, and 4, when a new prescription is inscribed on a standardized prescription form 74, the new prescription dataset 25 describing the new prescription is inscribed thereon in predefined standardized fields 76. The reading module 64 reads the data inscribed in each field 76 and converts the data inscribed therein into a format readable by computing devices, such as, for example, a machine readable text format such as ASCII or the like. For example, the reading module 64 may include handwriting recognition software 200 for, when the new prescription dataset 25 is inscribed in the fields 76 on the standardized form 74 by hand, converting the data in the fields 76 into the machine readable text format. The reading module 64 may also include Optical Character Recognition (OCR) software 202, thus allowing the reading module 64, when the prescription dataset is inscribed in the fields 76 on the pre-defined form 74 in typewritten format printed characters, to convert the characters, and thereby the data in the fields, into the machine readable text format. Once converted into the machine readable format, the new prescription dataset 25 is stored in the prescription database 70, along with the scanned prescription image 59, as previously described. The new prescription dataset 25 in the machine readable format may also be forwarded, along with or in place of the scanned prescription image 59, to the PHPD 16. Refill prescription datasets 27 may also be stored in the prescription database 70.

Referring to FIGS. 3, 3a, and 4, the signature module 78 includes signature recognition software 204 for, when a new prescription is inscribed in the fields 76 on the pre-defined prescription form 76, reading a field 76d from the scanned prescription image 59 in which the prescriber's handwritten signature is inscribed, and comparing the image of handwritten signature in the field 76d against a previously provided stored signature image 47 of the prescriber's handwritten signature stored in the prescriber database 48. Based on the degree of similarity between the handwritten signature on the scanned prescription image 59 of the standardized prescription form 74 and the stored signature image 47, the signature module 78 generates a signature reliability score 81, which is sent by the SCD 12 to the PPRD 16 and, preferably, stored in the prescription database 70 along with the new prescription dataset 25 in the prescription record 206 for the prescription. The pharmacist at the selected pharmacy 24 may then use the signature reliability score 81 to determine whether or not to fill the prescription. The prescriber record 208 in the prescriber database 48 corresponding to the prescriber is, preferably, cross referenced with the name of the prescriber read by the reading module 64 to better ensure that the correct record 208 in the prescriber database 48 is referenced. By permitting evaluation of the prescriber's handwritten signature, the system 10 reduces the risk of unauthorized persons inscribing prescriptions on the standardized prescription forms 74, thus reducing the risk of prescription fraud. As stated earlier, the SCD 12 may have a signature pad 46 connected thereto for inscription by the prescriber of the prescriber's signature thereupon to provide the stored signature image 47 for storage in the prescriber database 48.

Referring still to FIGS. 1, 2 and 3, the PCD 14 also has a CPU 52, which controls the prescriber scanner 44 and, when deployed, the signature pad 46. The CPU 52 of the PCD 14, in turn receives instructions from the PCD software module 80. The PCD 14 communicates with the SCD 12 via the network interface 58. For new prescriptions, the prescriber scanner 44 receives a prescription form 74, 75 having the new prescription dataset 25 inscribed thereon from the prescriber. The prescription form is scanned by the prescriber scanner 44, also controlled by a scanner control module 54 on the PCD 14, into a scanned prescription image 59 thereof, in the same fashion as for the CCD 12 and is forwarded to the SCD 12. When received at the SCD 12, the scanned prescription image 59 is then stored thereupon in the prescription database 70 and, if the prescription form is a standardized prescription form, the new prescription dataset 25 is read from the scanned prescription image 59 by the reading module 64, as described above for the SCD 12. The signature module 66 may also generate a signature reliability score 81 for the prescription transmitted from the PCD 14, also as described for the SCD 12.

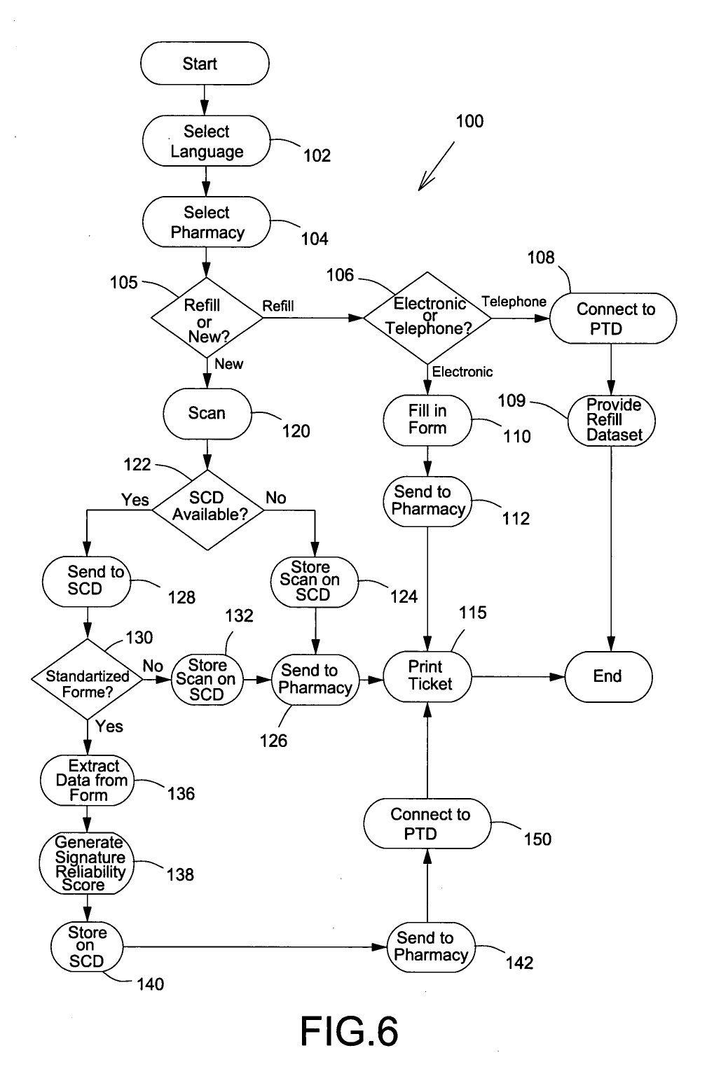

Referring now to FIG. 6, therein is shown a flow chart for a method, shown generally as 100, for processing a prescription, using system 10, in accordance with the present invention. At step 102, the client may, optionally, select a desired language for interaction with the system 10 from a list of available languages displayed on the screen 38 of the CCD 12 by using the client input devices 34, 36, 38. Next, at step 104, the CCD 12 receives a pharmacy selection indicating the selected pharmacy 24 from a list of available pharmacies provided from the pharmacy database 60 and displayed on the screen 38. The pharmacy selection is made, as described previously, by the client who selects the selected pharmacy 24 using a client input device 34, 36, 38. At step 105, the system 10 receives a selection from the client at the CCD 12, using a client input device 34, 36, 38, indicating whether the prescription to be transmitted to the selected pharmacy 24 is a refill prescription or a new prescription.

If the refill prescription is selected, a refill method selection is received, at step 106, by the CCD 12 from the client who selects the refill method selection by using the client input devices 34, 36, 38 of the CCD 12. At step 106, the client is presented with two choices on the screen 38 of the CCD 12, namely transmitting the refill prescription, and specifically the refill prescription dataset 27 therefor, to the pharmacy electronically or by telephone. If the client chooses to transmit the refill prescription by telephone, then, the CCD 12, and specifically the telephony control module 50, instructs the CTD 30, at step 108, to dial the PTD telephone number 82 of the PTD 40 of the selected pharmacy 24, stored in the pharmacy database 60, to establish a telephone connection therebetween over the second network 42. Still at step 108, once the telephone connection has been established, the CCD 12 generates a visual or sonorous signal to indicate that the telephone connection has been established. The client then, at step 109, verbally provides the refill prescription dataset 27, described previously, to the prescriber at the selected pharmacy 24 via the telephony devices 30, 40, after which the telephone connection is terminated.

Accordingly, the refill prescription dataset 27 has been transmitted to the selected pharmacy 24 and the client may subsequently attend at the selected pharmacy 24 to retrieve the refilled prescription. The processing of the prescription, accordingly, ends.

If the client chooses to transmit the refill prescription electronically, then, at step 110, the client enters the prescription refill dataset 27 into an electronic refill form displayed on the screen 28 of the CCD 12 using the client input devices 34, 36, 38 on the CCD 12. Once the CCD 12 has received the refill prescription dataset, the CCD 12 transmits the refill prescription dataset 27, at step 112, to the PPRD 16 of the selected pharmacy 24, possibly via the SCD 12, over the first network 20 using the electronic address thereof 86. For example, when the electronic address 86 is an e-mail address, the CCD 12 or SCD 18 may transmit the refill prescription dataset 27 as an electronic mail, encrypted or unencrypted, to the electronic address 86. The refill prescription dataset 27 may also, optionally, be stored on the CCD 12 or SCD 18, and notably the prescription dataset 70, at step 112. Proceeding to step 115, a client ticket 94, possibly having a unique transaction code, such as the prescription identifier 210, inscribed thereon, is then printed from the client printer 28 confirming, for example, the selected pharmacy 24 to which the prescription has been transmitted, the time and date of the transaction, or the like, at step 115. Once the ticket 94 is printed, the processing of the prescription ends.

Should the client opt, at step 104, to process a new prescription, then, at step 120, the client introduces the prescription form 74, 75 having the new prescription dataset 25, described previously, inscribed thereupon, into the client scanner 26 on the CCD 12. The prescription form is thus received by the client scanner 26, and the scanner controller 54, activates the scanner 26 which scans the prescription form 74, 75 into a scanned prescription image 59 which contains a scanned image of the form 74, 75 and thereby of the new prescription dataset 25. The scanned prescription image 59 is received, via the scanner controller module 54, by the CCD 12. Next, at step 122, the CCD 12 verifies whether the SCD 12 is present and accessible by the CCD 12 via the first network 20. If the SCD 12 is not accessible, then, at step 124, the CCD 12 stores a copy of the scanned prescription image 59, possibly in a local copy of the prescription database 70 resident on the CCD 12. The CCD 12 then, at step 126, electronically transmits the scanned prescription image 59 over the first network 20 to the PPRD 16 of the selected pharmacy 24, i.e. to the electronic address 86 the PPRD 16 stored in the pharmacy database 60. Thus, a copy or mirror of the pharmacy database 60 is maintained on each CCD 12, or the pharmacy database 60 is otherwise made accessible thereto, in case the SCD 18 is inaccessible.

If it is determined that the SCD 18 is accessible to the CCD 12 on the first network 20 at step 122, then the CCD 12 electronically transmits the scanned prescription image 59 to the SCD 12 over the first network 20 at step 128. The SCD 18 receives the scanned prescription image 59 and, at step 130, verifies whether or not the scanned prescription image 59 is a scanned image of a standardized prescription form 74, described previously, for example by checking for the presence of a form marker 96, such as bar code, character code, or image specific to the standardized prescription form 74 and therefore present on the scanned prescription image 59 thereof. This test may, for example, be conducted by the reading module 64. If the scanned prescription image is not an image of a standardized prescription form 74, indicating that the new prescription is inscribed on a non-standardized form 75, then, at step 132, the SCD 12 stores the scanned prescription image 59, containing an image of the new prescription dataset 25, in the prescription database 70. The scanned prescription image 59 is then, at step 134, electronically transmitted by the SCD 12 to the PPRD 16, using the electronic address 86 thereof stored in the pharmacy database 60, in the same fashion as done by the CCD 12 at step 126.

If the CCD 12 determines, at step 130, that the scanned prescription image 59 is an image of the standardized prescription form 74, i.e. that the form marker 96 is present, then, at step 136 the reading module 64 reads the information in the prescription fields 76, as previously described, and converts the information in the information in the prescription fields 76 into the machine readable text format, as described previously. Conversion of the portion of the scanned prescription image 59 having the signature image in the signature field 76d into the machine readable text format may be omitted at step 136. However, the image in the signature field 76d is nonetheless extracted by the reading module 64 and, at step 138, transmitted to the signature module 66 which compares the image with a stored signature image 47 stored in the prescriber database 48 and generates a signature reliability score 81, as previously described, based on the degree of similarity between image in the signature field 76d and the stored signature image. Next, at step 140, the new prescription dataset 25, in the machine readable text format, the scanned prescription image 59, and the signature reliability score 81 are stored in a prescription record 206 in the prescription database 70 on the SCD 18. Proceeding to step 142, the scanned prescription image 59, the signature reliability rating 81, and, if desired, the new prescription dataset 25 in the machine readable text format, are transmitted from the SCD 18 to the PPRD 16 of the selected pharmacy 24, using the electronic address 86 thereof stored in the pharmacy database 60. At step 150, the CCD 12, and specifically the telephone control module 56 thereof, establishes a telephone connection between the client telephony device 30 and the pharmacy telephony device 40, in the same manner as for step 108. The client may then verbally confirm the new prescription dataset 25 with the pharmacist at the selected pharmacy using the telephone connection. Regardless of the manner in which the new prescription is transmitted to the selected pharmacy 24, the client printer 28 prints, at step 115, a confirmation ticket for the client at step 115, after which the method 100 is terminated.

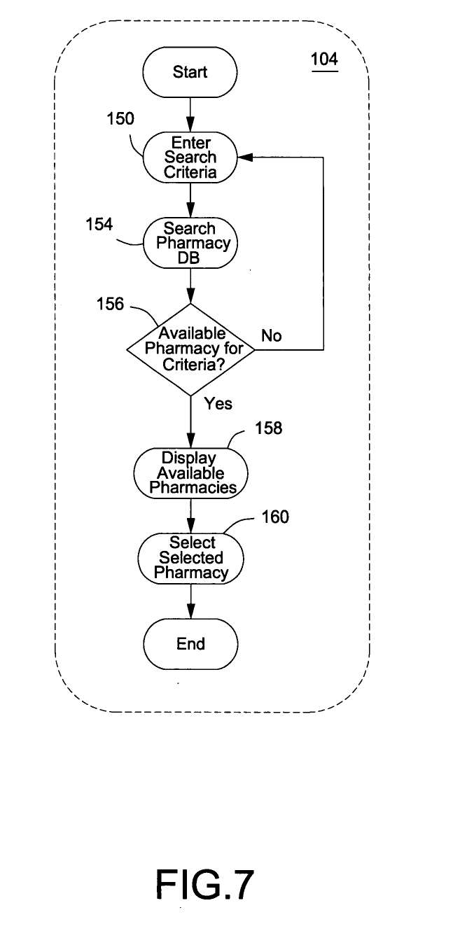

To better aid the user in understanding how the selected pharmacy is selected at step 104, reference is now made to FIG. 7, a flow chart for selecting the selected pharmacy 24 at step 104. As shown, at step 150, the client enters at least one search criterion on the CCD 12 using the client input devices 34, 36, 38. The search criterion may include the pharmacy name 230, postal code 234, pharmacy address 232, the city or locality 236 in which a pharmacy 24 is located, the hours of business 238, of the pharmacy, the postal code of the pharmacy, or the like. Next, at step 154, the CCD 12 accesses the pharmacy database 60, either on the CCD 12 or on the SCD 18 by sending a search request thereto, and a search is conducted in the pharmacy database 60 for all pharmacies 24 having the criteria entered on the CCD 12. If the CCD 12 does not identify any pharmacies 24 corresponding to the criteria, verified thereby at step 156, then the CCD 12 returns to step 150. However, if, at step 156, at least one pharmacy corresponds to the search criterion, then the pharmacy 24 or pharmacies 24, and more specifically data therefore from the pharmacy database 60, corresponding to the search criteria are displayed on the screen 38 of the CCD 12 as a list of available pharmacies 24 at step 158, possibly along with their address, hours of opening, driving instructions, or the like. The CCD 12 then receives form the client, at step 158, a pharmacy selection from the list of the available pharmacies 24 made by the client using the client input devices 34, 36, 38, the pharmacy 24 selected being the selected pharmacy 24.

With regard to the entry of new prescriptions into the system 10 by the prescriber using the PCD 14, this is effected, as described previously, at the PCD 14 using the prescriber scanner 44, in much the same way as when a client transmits a new prescription on the CCD 12. Specifically, the prescriber enters the prescription into the prescriber scanner 44. The PCD 14 receives the scanned prescription image 59 from the prescriber scanner 44 and then transmits the scanned prescription image 59 to the SCD 18. The SCD 18 then handles the scanned prescription image 59 in exactly the same fashion as in steps 130, 132, 136, 138, and 140. However, the scanned prescription image 59, signature reliability score 81, and new prescription dataset 25 in machine readable format are not transmitted to the PPPD 16, since no pharmacy 24 is specified. Further, if desired, the signature reliability score 81, scanned prescription image 59, and prescription dataset 25 in machine readable format may also be stored, in association with the prescriber, in the prescriber database 48 or in the prescription database 70 with a reference to the prescriber in the prescriber database 48.

While a specific embodiments have been described, those skilled in the art will recognize many alterations that could be made within the spirit of the invention, which is defined solely according to the following claims.

I claim:

1. A method for processing a prescription prescribing medication wherein the prescription is transmittable to a selected pharmacy by a client situated at a remote location remote from the selected pharmacy, said method comprising the steps of:
a) receiving a pharmacy selection designating the selected pharmacy from the client at the remote location;
b) when the prescription is a refill prescription, transmitting a refill prescription dataset describing said refill prescription to the selected pharmacy;
c) when the prescription is a new prescription;
i) scanning a prescription form having a new prescription dataset defining the new prescription inscribed thereon into a scanned prescription image thereof containing said new prescription dataset;
ii) electronically transmitting said scanned prescription image to the selected pharmacy;
v) establishing a telephone connection between the remote location and the selected pharmacy; and
vi) using said telephone connection, verbally confirming by a pharmacist with the client of said new prescription dataset in the scanned prescription image received at the selected pharmacy.

2. The method of claim 1, wherein said refill prescription dataset is transmitted electronically.

3. The method of claim 1, wherein said telephone connection is also established for transmitting said refill prescription dataset, said refill prescription dataset being transmitted verbally from said remote location to the selected pharmacy using said telephone connection.

4. The method of claim 1, wherein said step of transmitting said scanned prescription image comprises the step of transmitting said scanned prescription image from a client computing device to a pharmacy prescription receiving device situated at said selected pharmacy over a data-enabled network connecting said client computing device to said pharmacy prescription receiving device.

5. The method of claim 1, wherein establishing said telephone connection comprises the steps of:
instructing a client telephony device from a client computing device connected thereto and situated therewith in the remote location to dial a respective pharmacy telephony device number for a pharmacy telephony device operated by the selected pharmacy to a client telephony device to establish said telephone connection over a telephony-enabled network connecting said client telephony device and said pharmacy telephony device; and
emitting at least one of an audio alert signal or visual alert signal from said kiosk when said telephone connection is established.

6. The method of claim 1, wherein said step of selecting the selected pharmacy comprises the steps of:
displaying a list of available pharmacies on a screen of a client computing device situated in the remote location; and
receiving a pharmacy selection indicating the selected pharmacy from said list from a client input device connected to said client computing device.

7. The method of claim 6, wherein said step of selecting the selected pharmacy further comprises the steps of:
receiving of at least one criterion entered by a client from said client input device; and
searching a pharmacy database for at least one pharmacy corresponding to said criterion, and displaying said at least one pharmacy corresponding to said criterion as said list of said available pharmacies.

8. The method of claim 1, wherein said prescription form is a standardized prescription form having a plurality of predefined fields in which said new prescription dataset is inscribed, said method further comprising the step of converting said new prescription dataset in said fields from said scanned prescription image into a machine readable text format readable by a computing device.

9. The method of claim 8, wherein said new prescription dataset comprises a written signature inscribed by a prescriber in a signature field of said fields, said method further comprising the steps of:
reading from said scanned prescription image a scanned signature image of said written signature from said signature field in;
comparing said first signature image against a stored signature image associated with the prescriber on a server computing device using a signature recognition software; and
based on said comparing, generating a signature reliability score based on a degree of resemblance between said scanned signature image and said stored signature image.

10. The method of claim 9, wherein said step of electronically transmitting said new prescription dataset comprises transmitting said signature reliability score to said pharmacy for use thereby in authenticating the prescription.

11. The method of claim 8, wherein said new prescription dataset comprises a patient name for a patient for whom the prescription is precribed, a prescriber name for the prescriber, and medicinal information describing a medication prescribed in the prescription and a dosage therefore, said said patient name, said prescriber name, and said medicinal information being inscribed in respective said fields therefore on said predefined standardized prescription form, and said step of converting said new prescription dataset comprises reading said medicinal information, said patient name, and said prescriber from said scanned prescription image with one of optical character recognition software and handwriting recognition software on a server computing device and converting said patient name, said prescriber name, and said medicinal information to said machine readable text format.

12. The method of claim 11, wherein said patient name, said prescriber name, and said medicinal information in said machine readable text format is transmitted to the selected pharmacy.

13. The method of claim 12, further comprising the step of storing said patient name, said prescriber name, and said medicinal information in said machine readable text format in at least one database on said server computer.

14. The method of claim 1, wherein said pharmacy selection is received in the remote location by a client computing device situated therein, said step of scanning the prescription form is effected from a client scanner connected to said client computing device, and said step of establishing a telephone connection is effected from a client telephony device connected to said client computing device, said client computing device controlling said client scanner and said client telephony device and being housed therewith in a kiosk situated in the remote location.

15. A prescription processing system for enabling transmission of a prescription emitted by a prescriber for a patient to a selected pharmacy from a remote location situated remote from the selected pharmacy, said system comprising:
at least one client scanner situated in the remote location for scanning a prescription form on which a new prescription dataset for a new prescription is inscribed into a scanned prescription image containing said new prescription dataset;
at least one client telephony device situated in the remote location; and
at least one client computing device connected to said client scanner, to the client telephony device, and to a pharmacy database of available pharmacies, the client computing device receiving a pharmacy selection from a client in the remote location designating the selected pharmacy from said available pharmacies, receiving said scanned prescription image from said client scanner, transmitting said scanned prescription image to a pharmacy prescription receiving device accessible from the selected pharmacy and connected to said client computer device by a data-enabled network, and controlling establishment of a telephone connection over a telephony-enabled network by said client telephony device with a pharmacy telephony device, connected thereto by said telephony-enabled network, for verifying said new prescription dataset.

16. The system of claim 15, further comprising a kiosk in which said client scanner, said client telephony device, and said client computing device are housed in the remote location.

17. The system of claim 15, further comprising a server computing device connected to said data-enabled network, said server computer receiving said scanned prescription image from said client computing device and storing said scanned prescription image in a client prescription database situated on said server computing device.

18. The system of claim 17, wherein said prescription form is a standardized prescription form having a plurality of fields in which said new prescription dataset is inscribed, said server computing device comprising a reading module for reading said new prescription dataset in said fields from said scanned prescription image and for converting said new prescription dataset into a machine readable text format, said new prescription dataset in said machine readable text format being stored on said server computing device.

19. The system of claim 18, wherein said new prescription dataset comprises a written signature inscribed by a prescriber on said standardized prescription form and said server computing device further comprises a signature recognition module for comparing a scanned signature image of said written signature from said scanned prescription image against a stored signature image of a sample signature of the prescriber provided previously thereby and stored on said server computing device and generating a signature reliability score based on a degree of resemblance between said scanned signature image and said stored signature image for use in verifying said prescriber signature on said standardized prescription form.

20. The system of claim 18, wherein said new prescription dataset is inscribed on said standardized prescription form by hand and said reading module comprises handwriting recognition software for converting said new prescription dataset into said machine readable text format.

21. The system of claim 18, wherein said new prescription dataset is inscribed on said standardized prescription form in typewritten form and said reading module comprises optical character recognition software for converting said new prescription dataset from said scanned prescription image of said standardized prescription form into said machine readable text format.

22. The system of claim 19, wherein said scanned prescription image and said signature reliability score are transmitted to said pharmacy prescription receiving device of the selected pharmacy by said server computing device.

23. The system of claim 19, further comprising a digital signature pad connectable to said server computing device and upon which said prescriber inscribes said sample signature, said digital signature pad converting said sample signature into said stored signature image and transmitting said stored signature image to said server computing device which stores said stored signature image in association with said prescriber.
